(19) United States
(12) Patent Application Publication
(10) Pub. No.: US 2025/0116252 A1
(43) Pub. Date: Apr. 10, 2025

(54) SYSTEM FOR HARNESSING A PRESSURE FLUCTUATION OF A LIQUID

(71) Applicant: Paul Andrew BATEMAN, Tyne and Wear (GB)

(72) Inventor: Paul Andrew BATEMAN, Tyne and Wear (GB)

(21) Appl. No.: 18/730,042

(22) PCT Filed: Dec. 14, 2022
(86) PCT No.: PCT/GB2022/053225

§ 371 Date: Jul. 18, 2024

(30) Foreign Application Priority Data
Jan. 18, 2022 (GB) 2200599.5

(51) Int. Cl. F03B 13/14; F03B 13/24

(52) U.S. Cl. CPC F03B 13/148; F03B 13/24; F05B 2210/18

(57) ABSTRACT

A system for harnessing water pressure fluctuation includes an accumulator element, a pneumatic actuator, and an electrical generator. The accumulator element has a reception space for receiving water, a container space for containing air, and a flexible diaphragm to separate the water from the air. The pneumatic actuator has a cylindrical enclosure element and a piston rod element movable relative to the enclosure element. Pressure fluctuation in the water causes a pressure fluctuation in the air, which in turn causes movement of the piston rod element relative to the enclosure element. The system includes a crank shaft element to convert translational movement of the piston rod element into rotational movement of the shaft element. The crank shaft element is connected to the electrical generator. Movement of the piston rod element relative to the enclosure element causes rotational movement of the shaft element, which causes the generator to generate electrical power.

This invention relates to a system for harnessing a pressure fluctuation of a liquid.

According to the invention there is provided a system for harnessing a pressure fluctuation of a liquid, the system comprising:
an accumulator element having a reception space for receiving a liquid and a container space for containing a gas,
the accumulator element having a transfer element to transfer an input pressure fluctuation in the reception space to an output pressure fluctuation in the container space, and
a pneumatic actuator,
the container space being coupled to the pneumatic actuator to cause movement of at least part of the pneumatic actuator responsive to the output pressure fluctuation.

In this manner the invention enables the energy associated with the pressure fluctuation of the liquid to be harnessed and converted into movement of the mechanical part of the pneumatic actuator.

The transfer element may comprise a flexible diaphragm to separate the reception space from the container space. The diaphragm provides a simple and efficient means of converting the pressure fluctuation in the liquid into a pressure fluctuation in the gas.

The system may comprise one or more valve elements between the container space and the pneumatic actuator to couple the container space to the pneumatic actuator.

The pneumatic actuator may comprise an enclosure element and a piston rod element, the piston rod element being movable relative to the enclosure element in a translational manner. The enclosure element may comprise a cylinder element. The system may comprise means to convert translational movement of the piston rod element into rotational movement of a shaft element. The means to convert may comprise a crank shaft element. The system may comprise means to connect the crank shaft element to a flywheel element.

The means to connect may comprise a gear mechanism. The system may comprise means to generate electrical power from the rotational movement of the shaft element. In this manner the invention enables the energy associated with the pressure fluctuation of the liquid to be harnessed and converted into electricity. The means to generate may comprise an electrical generator. The means to generate may comprise a pulley belt to connect the flywheel element to the electrical generator.

The reception space of the accumulator element may be configured to receive water. The system may comprise means to couple the reception space of the accumulator element to an open loop water system. The system may comprise means to couple the reception space of the accumulator element to a potable open loop water system. In this manner the invention enables the energy associated with commonplace pressure fluctuations in the open loop water system or the potable open loop water system to be harnessed and converted into electricity. The open loop water system or the potable open loop system may be a mains cold water service or a boosted cold water service. The invention is suitable for use with a water company owned network or an independently owned network, for example a privately owned network such as on a hospital site. The container space of the accumulator element may be configured to contain air or nitrogen.

The pneumatic actuator may be a sealed non-relieving non-exhausting pneumatic system. The system may comprise a motorised control valve to direct the liquid to the accumulator element in the event of a liquid draw off event. The two-port control valve in the potable open loop system enables the invention to harvest energy even if the potable open loop system is used as a fill line to a cold water storage tank. The system may comprise a pneumatic vane motor.

The invention also provides in another aspect a method for harnessing a pressure fluctuation of a liquid, the method comprising the steps of:
containing a gas in a container space of an accumulator element,
receiving a liquid in a reception space of the accumulator element,
upon a pressure fluctuation in the liquid in the reception space, transferring the pressure fluctuation to the gas in the container space, and
causing movement of at least part of a pneumatic actuator responsive to the pressure fluctuation in the gas.

In this manner the invention enables the energy associated with the pressure fluctuation of the liquid to be harnessed and converted into movement of the mechanical part of the pneumatic actuator.

The pressure fluctuation in the gas may cause movement of the part of the pneumatic actuator in a translational manner. The method may comprise the step of converting translational movement of the part of the pneumatic actuator into rotational movement of a shaft element. The method may comprise the step of generating electrical power from the rotational movement of the shaft element. In this manner the invention enables the energy associated with the pressure fluctuation of the liquid to be harnessed and converted into electricity.

The method may comprise the step of coupling the reception space of the accumulator element to an open loop water system. The method may comprise the step of coupling the reception space of the accumulator element to a potable open loop water system. In this manner the invention enables the energy associated with commonplace pressure fluctuations in the open loop water system or the potable open loop water system to be harnessed and converted into electricity.

Embodiments of the present invention will now be described hereinafter, by way of example only, with reference to the accompanying drawings, in which:

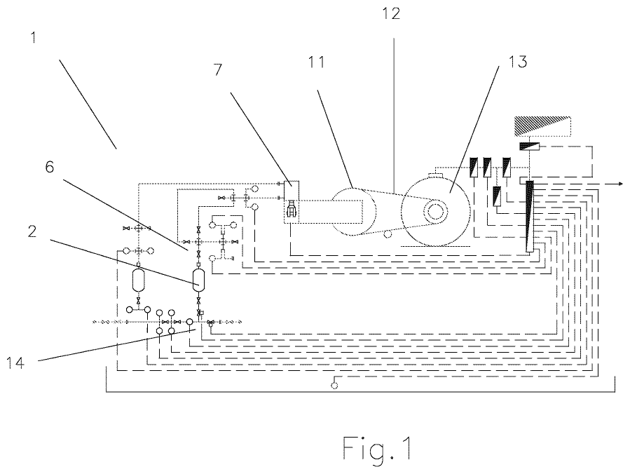

FIG. 1 is a schematic illustration of a system according to the invention for harnessing a pressure fluctuation of a liquid;

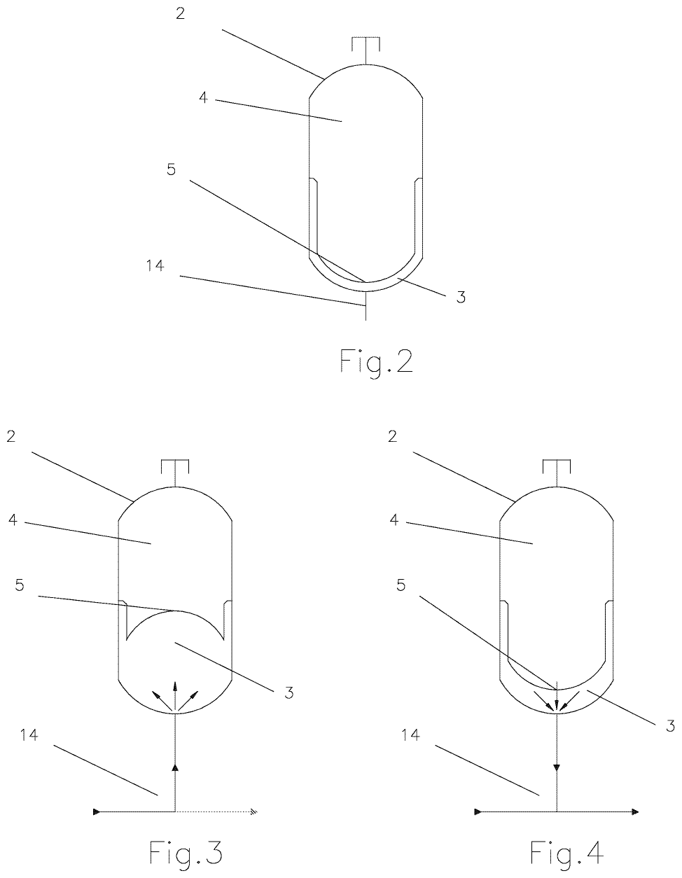

FIGS. 2 to 4 are front views of an accumulator element of the system of FIG. 1, in use;

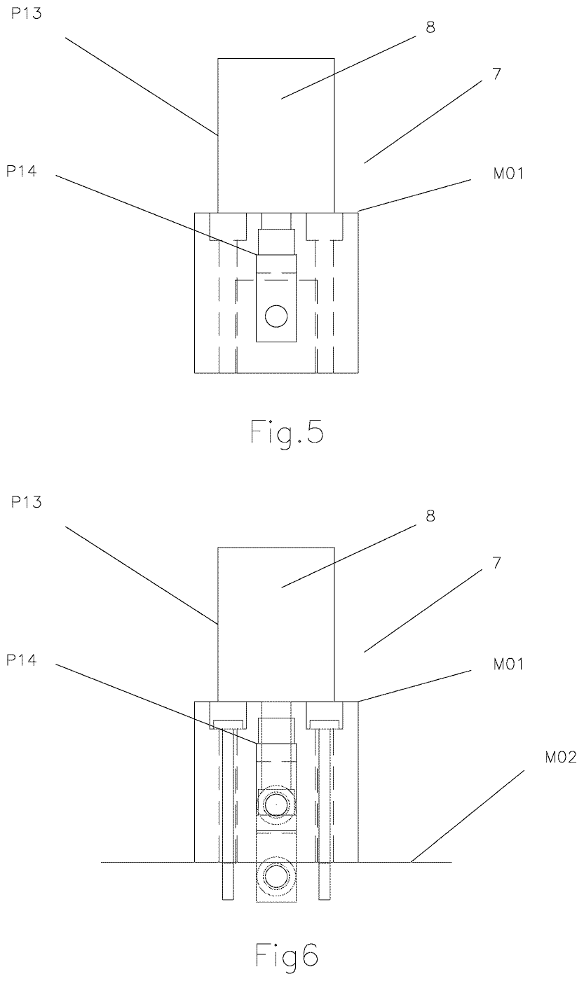

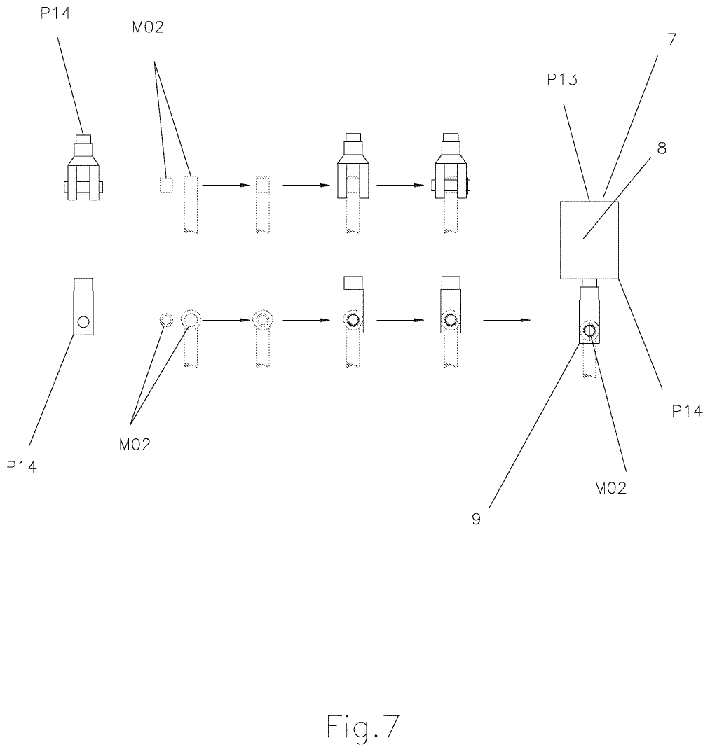

FIGS. 5 and 6 are front views of a pneumatic actuator of the system of FIG. 1;

FIG. 7 is an exploded view illustrating assembly of the pneumatic actuator of FIGS. 5 and 6;

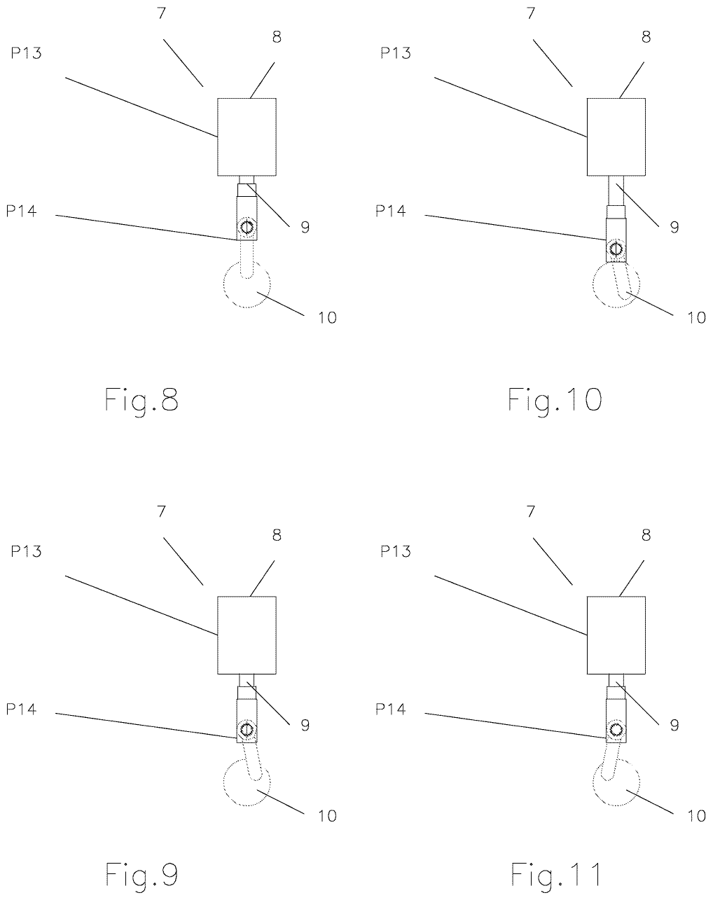

FIGS. 8 to 11 are front views of the pneumatic actuator of FIG. 7, in use;

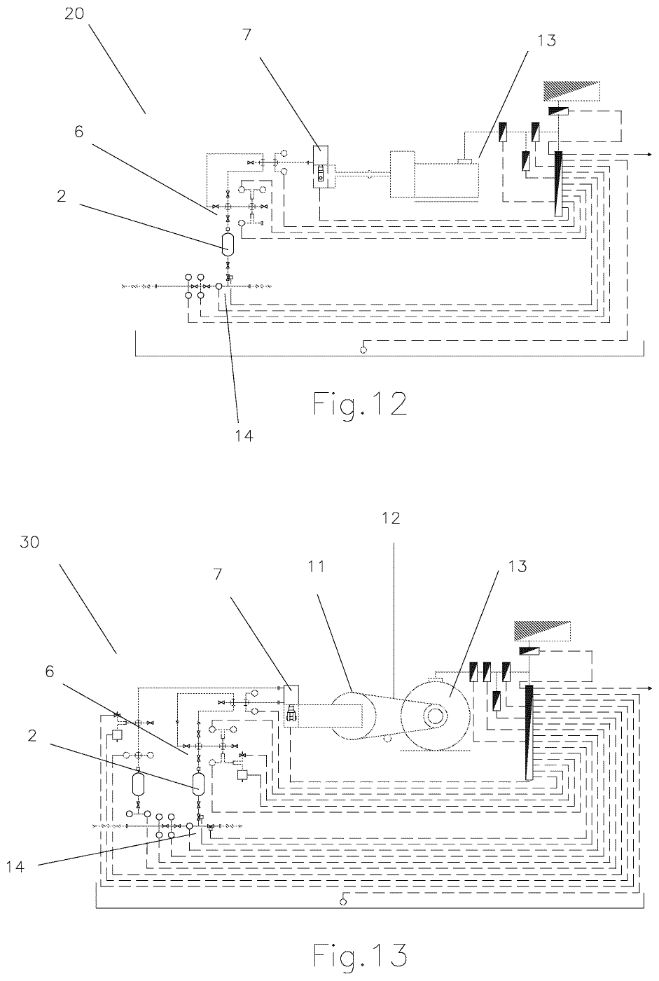

FIG. 12 is a schematic illustration of another system according to the invention for harnessing a pressure fluctuation of a liquid;

FIG. 13 is a schematic illustration of a further system according to the invention for harnessing a pressure fluctuation of a liquid;

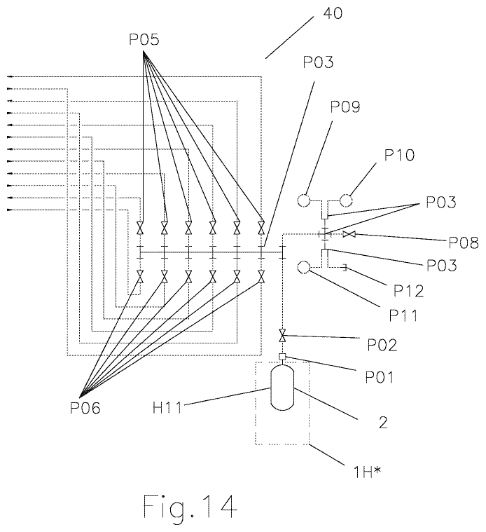

FIG. 14 is a schematic illustration of part of a further system according to the invention for harnessing a pressure fluctuation of a liquid; and

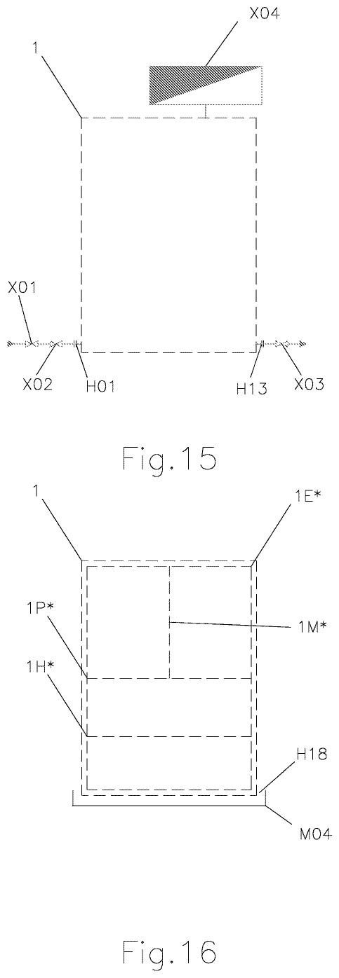

FIGS. 15 to 39 are schematic illustrations of parts of further systems according to the invention for harnessing a pressure fluctuation of a liquid.

In the drawings like reference numerals refer to like parts.

Referring to the drawings, and initially to FIGS. 1 to 11 thereof, there is illustrated a system 1 according to the invention for harnessing a pressure fluctuation of a liquid. The system 1 comprises an accumulator element 2, a pneumatic actuator 7, and an electrical generator 13 (FIG. 1).

The accumulator element 2 has a reception space 3 for receiving a liquid such as water, and a container space 4 for containing a gas such as air or nitrogen (FIG. 2). In the following description the container space 4 will be described in relation to the instance where the container space 4 contains air. However it will be appreciated that the container space 4 may alternatively contain nitrogen or another gas. The reception space 3 of the accumulator element 2 is coupled to the mains cold water supply system 14 (FIG. 1). The system 1 is suitable for use in a domestic home.

The accumulator element 2 has a flexible diaphragm 5 to separate the water in the reception space 3 from the air in the container space 4 (FIG. 2). The flexible diaphragm 5 acts to transfer an input pressure fluctuation in the water in the reception space 3 to an output pressure fluctuation in the air in the container space 4. For example when water pressure increases in the reception space 3, this water pressure impinges on the diaphragm 5 to compress the gas in the container space 4, possibly up to 20 bar. For example when the water pressure in the reception space 3 decreases, the gas pressure in the container space 4 impinges on the diaphragm 5 to reduce the gas pressure in the container space 4, possibly to 4 bar.

The pneumatic actuator 7 is provided in the form of a cylindrical enclosure element 8 and a piston rod element 9 (FIG. 7). The piston rod element 9 is movable relative to the enclosure element 8 in a translational manner (FIGS. 8 to 11).

The system 1 comprises a series of valve elements 6 between the container space 4 of the accumulator element 2 and the enclosure element 8 of the pneumatic actuator 7 (FIG. 1). The valve elements 6 couple the air in the container space 4 to the piston rod element 9 of the pneumatic actuator 7. When there is an output pressure fluctuation in the air in the container space 4, this causes movement of the piston rod element 9 relative to the enclosure element 8 in a translational manner (FIGS. 8 to 11).

The system 1 includes a crank shaft element 10 to convert the translational movement of the piston rod element 9 into rotational movement of the shaft element 10 (FIGS. 8 to 11). The crank shaft element 10 is connected to a flywheel element 11 by means of a gear mechanism. The system 1 includes a pulley belt 12 to connect the flywheel element 11 to the electrical generator 13 (FIG. 1). When the piston rod element 9 moves relative to the enclosure element 8 in a translational manner, this causes rotational movement of the shaft element 10 which causes rotational movement of the flywheel element 11. When the flywheel element 11 rotates, this causes movement of the pulley belt 12 which causes the electrical generator 13 to generate electrical power.

As illustrated in FIG. 2, the Schrader valve may be used with the accumulator tank 2 or expansion vessel or water hammer arrestor or similar. This may be used to charge the cylinder with a gas, such as nitrogen or other similar inert gas. After the cylinder has been pre-charged with an inert gas the diaphragm 5 typically sits in a neutral position. The threaded connection enables connection of the accumulator vessel 2 to the hydronic system. FIG. 2 shows the accumulator vessel 2 not connected to the open loop system 14. This indicates how the main cold waters affects the gas pressure within the vessel 2.

As illustrated in FIG. 3, the positive water pressure inflates the diaphragm 5 and in doing so displaces the gas which elevates the gas pressure. When connected to the open loop water supply 14, such as the mains cold water service or similar, and no water is being drawn off by the property, the accumulator vessel 2 accumulates water. The open loop system 14, such as the mains cold water, pressurises the accumulator vessel 2. FIG. 3 shows the accumulator vessel 2 connected to the open loop system 14 during zero draw off event.

As illustrated in FIG. 4, the negative water pressure deflates the diaphragm 5 and thus provides more volume to the gas which reduces the gas pressure. When water is being drawn from the property, the negative pressure induced on the pipeline siphons water out of the accumulator tank 2. The open loop system 14, such as the mains cold water, siphons water from the network and the accumulator vessel 2. FIG. 4 shows the accumulator vessel 2 connected to the open loop system 14 during a water draw off event.

FIG. 8 shows the cooperation between the pneumatic cylinder 8 and the crankshaft 10 with an indication of the conversion from linear to rotational action.

In use, the reception space 3 of the accumulator element 2 is coupled to the mains cold water supply system 14. When there is an input pressure fluctuation in the water in the reception space 3, this causes movement of the flexible diaphragm 5 which causes an output pressure fluctuation in the air in the container space 4. The output pressure fluctuation in the air in the container space 4 causes the piston rod element 9 to move relative to the enclosure element 8 in a translational manner (FIGS. 8 to 11).

When the piston rod element 9 moves relative to the enclosure element 8 in a translational manner, this causes rotational movement of the shaft element 10 which causes rotational movement of the flywheel element 11. When the flywheel element 11 rotates, this causes movement of the pulley belt 12 which causes the electrical generator 13 to generate electrical power.

The system 1 may be used to generate electricity. In particular the system 1 may produce electricity from the open loop pipe water system 14, such as the potable open loop pipe water system. The system 1 may be used with the open loop pipe system 14 without risks relating to legionella or other forms of micro-biological hazard.

The system 1 harvests the kinetic energy from the potable open loop pipe system when water is being drawn off. The system 1 converts this kinetic energy into electrical energy.

The system 1 may be operated in association with the open loop pipework system 14 without any risk of causing damage to the open loop pipework system.

The system 1 may be constructed in a small, compact form without large expense.

The system 1 is provided in the form of a hydro pneumatic accumulator generator. The system 1 includes the vessel 2, such as an accumulator tank, expansion vessel, water hammer arrestor or similar, with the integral diaphragm 5, bladder or similar. The container space 4 of the accumulator 2 is charged with an inert gas such as oxygen, nitrogen or similar. The vessel 2 is connected to the open loop pipe system 14 where it accumulates water in a controlled fashion and discharges it during water draw off. This process leans into the pocket of gas 4 which is compressed and decompressed, thus creating pressure fluctuations (FIGS. 2 to 4). When the open loop pipe system 14 is sealed, i.e. when there is no water being drawn off, water accumulates in the vessel 3, which forces the diaphragm 5, bladder or similar to balloon out into the volume where the gas resides. This displaces the gas and elevates the gas pressure (FIG. 3). When the open loop pipe system 14 is open, i.e. when water is being drawn off, a negative pressure is induced on the water contained within the vessel 3 which siphons the water out of the vessel 3 at a rapid rate. This pull force is complemented by the push force of the high-pressure gas. The combination of these two actions results in the diaphragm 5, bladder or similar flattening out which gives up volume back to the gas which in turn reduces the pressure of the gas (FIG. 4).

The gas side pressure fluctuations are then used to produce mechanical work by connecting the vessel 4 to the sealed pneumatic system 7. The inert gas ensures that should there be a compromise in the bladder, diaphragm 5 or similar, then the inert gas would not contaminate the water supply.

The vessel 2 may be connected to many types of open loop system 14 including, the mains cold water network, local booster cold water network, local gravity system and the hot water cold feed or similar. The hot water cold feed to a hot water generator may allow both pressure fluctuations arising from the network and thermal expansion to be harvested by the system 1. In the event the system 1 is installed on the fill line upstream of a cold water storage tank, a spring open two-port solenoid control valve or two-port solenoid valve or two- port pneumatic powered control valve or similar two-port control valve may be installed as a rapid open/close device for artificially creating pressure fluctuations in the open loop system 14 for optimising energy harvest. In the event of a fault or a loss of power, the rapid on/off valve would fail open and not hinder the operation of the open loop pipe system 14. In this manner the system 1 ensures continuity of the open loop pipe system service in a fail event for resilience purposes. The system 1 utilises a spring closed two-port solenoid control valve or two-port solenoid control valve or similar as a safety device for isolating the vessel 2 from the open loop pipe system 14 in a fail event.

The gas side 4 of the vessel 2 is connected to the sealed or closed loop pneumatic system 7 for transferring the energy to a mechanical device.

The inert gas is not exhausted to atmosphere during normal operation. An exception to this may be if automatic exhaust valves and compressors/gas bottles with control valves are installed for remotely optimising the gas pressure through a controller.

The system 1 employs a pneumatic pressure regulator and bypass with a non-return valve to step down the gas pressure for safe operation with a pneumatic mechanical output device 7; and to allow gas to rapidly bypass the pneumatic pressure regulator. This allows the gas to be pushed into and extracted out of the pneumatic mechanical output device 7 rapidly. If there is an excess amount of gas pressure available, the gas may be used to drive multiple pneumatic mechanical output devices for increasing the amount of electricity produced by the system 1 from a single vessel 2 using a pneumatic manifold. The system 1 may use different types of pneumatic mechanical output device 7, such as a single acting rolling diaphragm pneumatic cylinder or a double acting rolling diaphragm pneumatic cylinder or a spring loaded single acting pneumatic cylinder or a gas loaded single acting pneumatic cylinder or a double acting pneumatic cylinder or multi-position pneumatic cylinder or tandem pneumatic cylinder or rod-less pneumatic cylinder, split-seal, slot type or cable type, or pneumatic bellows or pneumatic brake chamber or pneumatic muscle attenuator or impact and knocking cylinders or pneumatic rack and pinion or pneumatic scotch yoke actuator or vane type actuator or any other similar pneumatic final control element for producing mechanical work.

The pneumatic mechanical output device 7 does not relieve or exhaust the gas to atmosphere during normal operation. The system 1 also minimises blow-by which relates to residual air leakage between the rod 9 and O-ring.

The system 1 may include a second separate pneumatic sealed system to provide the return pressure to the double acting cylinder to return the rod 9 back to its start position when the pressure in the vessel pneumatic sealed system turns negative, i.e. when the gas is returning back to the vessel 2. A second vessel, such as an accumulator vessel, expansion vessel or water hammer arrestor or similar, charged with an inert gas may be used for this purpose connected to a sealed pocket of water to enable the system 1 to operate. This second pneumatic system may be connected to a compressor/gas bottle with automatic control valve in conjunction with an automatic exhaust valve to atmosphere, so that the pressure may be optimised through the controller.

The system 1 transfers the mechanical energy produced by the pneumatic mechanical output device 7 into the crankshaft 10 for ultimately turning the generator 13. The system 1 may be used with a continuously variable transmission with gearhead arrangement or direct drive with planetary gears or gearheads mounted direct to the generator 13 for increasing the torque of the drive onto the driven element. The system 1 uses an electrically actuated mechanical break for hard stopping the mechanical system in a fail-safe event. The system 1 uses a motor installed in reverse or a motor wired in reverse or a purpose-built generator for generating electricity. The system 1 uses a battery to store electricity in the event the electricity produced by the generator 13 is not immediately consumed at the point of connection to the greater electrical system or network or similar. The system 1 may utilise either an alternating current or direct current generator. If an alternating current generator is used, the system 1 includes a rectifier and inverter for harmonising the electricity produced by the generator with the greater electrical system or network or similar. If a direct current generator is used, the system 1 includes an inverter for harmonising the electricity produced by the generator 13 with the greater electrical system or network or similar unless the generator 13 is being used in a direct current application. The battery, if used, is installed before the inverter. The system 1 includes a relay device for breaking the circuit in a fail-safe event.

The system 1 includes an integral control system which monitors and takes recordings of the sensors and meter readings and controls all final control elements. The system 1 includes an interface to allow the system 1 to be fully monitored and/or controlled from an external control system, such as a building management system. The system 1 includes a water meter to monitor water draw off, which are recorded by the controller. The system 1 includes an electricity meter to monitor the electricity produced by the generator 13, which are recorded by the controller. The controller may receive a signal from a current transformer for monitoring the imported electricity from the grid to enable the system 1 to modulate/stop electrical export to avoid an event where electricity is exported to the distribution network owner's network or independent distribution network owner's network or similar.

The system 1 includes an adjustable hydronic pressure regulating valve and an adjustable pneumatic pressure regulating valve. These two valves allow the system 1 to be commissioned. The hydronic pressure regulating valve protects the system 1 from excessive pressure from the potable open loop system, which may then be balanced in relation to the pneumatic pressure regulating valve and vice versa to optimise the system 1.

The system 1 includes pneumatic exhaust relief valves to discharge the contents of the pneumatic sealed system to atmosphere if a dangerous high-pressure event occurs on both the upstream and downstream sides of the pneumatic pressure regulating valve and, if used, in the pneumatic sealed system serving as a return mechanism for the double acting cylinder.

The system 1 includes a plurality of pressure sensors and moisture sensors to inform the controller of the current state of each of the pneumatic sealed systems and the hydronic system. If a dangerous event is detected, the controller de-energises the safety control valves to enable the isolation of the system 1 while not influencing the operation of the open loop pipe system 14.

In further detail, the hydro pneumatic accumulator generator 1 includes a hydronic module, a pneumatic module, an electrical module, and a mechanical module.

The hydronic module may be connected to the open loop pipe system 14 at any point in the system. Particular connection points of interest include; to the mains cold water network upon entry to the property. This module may be connected to the system in place of a water hammer arrestor, and may be connected to a system in place of a cold-feed expansion vessel to a hot water generator where it may harvest energy from thermal expansion along with general system pressure fluctuations associated with the open loop system 14. If the hydronic module is fitted in a fill line upstream of a cold water storage tank, cistern or similar, then an optional spring open two-port control valve may be installed connected to a controller or repeat cycle to rapidly open and close the valve for artificially creating pressure fluctuations to suit the output of the electrical generator 13 during the fill period.

The pneumatic module includes a high-pressure side and a low-pressure side. The high-pressure side envelopes the pipework and components between the vessel 2 to the outlet of the non-return valve and the inlet to the pressure reducing valve. The low-pressure side of the system is from the inlet to the non-return valve and the outlet from the pressure reducing valve to the pneumatic cylinder 7. When the vessel 2 has absorbed the water pressure and has imposed a high-pressure event on the inert gas, the pressure of the inert gas rushes to the pressure reducing valve where it is stepped down for safe operation with the pneumatic cylinder 7. When water is being drawn from the open loop pipe system 14, the water pressure drops and the inert gas on the gas side of the vessel 2 rushes back to the vessel 2 down the bypass and through the non-return valve. This action acts to retract the piston 9 on the pneumatic cylinder 8. Retracting the piston 9 on the pneumatic cylinder 8 may be assisted mechanically by either matching a spring loaded single acting cylinder or matching a gas loaded single acting cylinder to the pneumatic load or using a double acting cylinder connected to another vessel, such as an accumulator tank, expansion vessel, water hammer arrestor or similar, with integral diaphragm, bladder or similar that is charged with an inert gas such as oxygen, nitrogen or similar. This arrangement allows for flexibility on site when commissioning the system 1, i.e. the vessel 2 may be pre-charged on site to match the load.

The pneumatic module is a sealed gas system, i.e. no part of the system is exhausted to atmosphere during normal operation. Residual gas leaks between the rod and the O-ring in the pneumatic cylinder 8 are avoided with a rolling diaphragm type single and double acting cylinder. In the event the vessel 2 has an excess amount of pneumatic pressure available when compressed, then a four-way-manifold may be exchanged for a multiple manifold to allow additional mechanical and electrical modules to be operated from a single vessel.

The electrical module includes a connection between the generator/motor 13 and the electrical network. If an alternating current generator is used, then a rectifier may be included followed by an inverter to correct the frequency of the electricity to match what is being imported from the grid. If a direct current generator is used, then an inverter may be included to make the electricity compatible with the grid. Alternatively, conversion may not be required if direct current is being drawn off at the point of connection to the electrical network. A four-pole motor or six-pole motor may be used which require a reduced number of revolutions per minute than a two-pole motor for producing electricity. The battery may be connected on the direct current side of the inverter.

The mechanical module converts the kinetic energy produced by the pneumatic module 7 into angular momentum for turning the generator 13. The mechanical module includes a crank pin, crank-shaft, bearings, continuously variable transmission, clutch, gearheads, main pulley wheel and break connected to the controller for hard-stop purposes (FIG. 7). The main pulley wheel 11 may be connected to the generator 13 via a pulley with tensioner pulley wheel. The crank pin is connected to the pneumatic piston 9 via a Y-clevis rod-end pin and a technical spacer to marry up the maximum out-stroke and minimum in-stoke of the rod 9 with the crank pin. The bush containing the bearing in the piston rod 9 may be ground down so that it can fit within the Y-clevis rod-end pin. Alternatively a direct drive system may be used in conjunction with planetary gears fitted direct to the generator 13.

The controller may be powered from the mains electrical network or from the power produced from the generator 13. The controller monitors the sensors, pressure sensors and moisture sensors, and equipment, water meter and electricity meter, and drives all final control elements, valves, relays, break, automatic exhaust valves and compressors.

In the hydronic module, if the water pressure drops signifying water draw off and the spring-open two-port control valve has been fitted, the valve is energised to close and de-energised spring open at intervals to suit the energy production of the generator 13. If an electrically powered two-port solenoid valve or a pneumatic powered two-port control valve is used, the driving force may be used to rapidly close and open the valve to maximise the energy harvesting of the generator 13.

In the pneumatic module, if moisture is detected in the pneumatic pipe system signifying a failure of the vessel 7, the hydronic valves de-energise, i.e. the spring-closed two-port control valve closes and the spring-open two-port control valve springs open. The vessel 2 is isolated from the open loop pipe system 14 without impacting on the operation of the open loop pipe system. In the event of a low pressure event in a part of the pneumatic system, the hydronic valves de-energise. In the event of a high pressure event in a part of the pneumatic system, the hydronic valves de-energise. In the event of water being detected in the drip tray, the hydronic valves deenergise. In the event of over-voltage or the frequency of the electricity produced is not harmonised with the imported electricity from the grid, the safety relay device opens. In the event an external signal from the building management system or similar calls for the system 1 to stop operation, the hydronic valves de-energise. In the event an external signal from the building management system or similar calls for the system 1 to hard-stop, a break is applied to the mechanical device 7. In the event current is detected through the earthing, the safety relay device opens.

The exposed pneumatic pipes may be contained within conduits. The rotating mechanical devices may be shrouded in a metal shell. The modules may be supplied on a common frame. Alternatively the hydronic module may be separate from the rest of the system 1.

The hydro pneumatic accumulator generator provides a means of generating renewable energy to achieve zero carbon homes and zero carbon buildings by producing renewable electricity local to the property.

The hydro pneumatic accumulator generator may be used with the open loop pipe system 14, for example the potable open loop pipe system such as a mains cold water service or a boosted cold water system or a gravity type system or similar. The system 1 uses pressure fluctuations from the open loop pipe system 14 to increase/decrease the pressure of the inert gas in the vessel 4 which then is used to produce mechanical work to ultimately turn the windings of the generator 13 for producing electricity.

The system 1 may be employed as a domestic version configured to be compact and be compatible with a domestic building or property which receives a water supply, has space beneath a kitchen sink, and has a consumer unit for exporting the electricity to. This would allow this piece of renewable technology to be installed in a wide variety of properties including a flat in an apartment block. The system 1 may also be employed as a commercial version with the hydronic module split away from the rest of the components, and with multiple generators 13 to be connected to a single vessel 2. If the connection is in a fill line upstream of a cold water storage tank, then an automatic control valve may be used to create pressure fluctuations to suit the energy harvesting.

The system 1 may be connected to a hot water cold-feed to a hot water generator whereby the vessel 2 acts as the expansion vessel. The system 1 may thus harvest the energy associated with thermal expansion along with the pressure fluctuations associated with the open loop pipe network 14.

The components of an embodiment of the system 1 with the hydronic module, the pneumatic module, the electrical module, and the mechanical module, will be discussed in further detail as follows.

### E01 ELECTRICAL

This device is the generator. In this case it is an alternating current motor which is being driven in order to produce electricity. The alternating current electricity produced is harmonised with electricity imported from the electricity grid before being used directly.

### E02 ELECTRICAL

This device is a safety relay device which is connected to the controller and in a fail safe event the controller de-energises the relay which breaks the circuit.

### E03 ELECTRICAL

This is a rectifier and it is used to convert alternating current into direct current. Its performance will be monitored by the controller.

### E04 ELECTRICAL

This is a battery which stores an amount of electrical energy before electricity is exported to the property. This battery will provide power to the controller as well as to a house if possible. Its performance is monitored by the controller.

### E05 ELECTRICAL

This device is an inverter for converting the direct current electricity generated by the device into alternating current which is harmonised with the electricity imported from the grid. Its performance is monitored by the controller.

### E06 ELECTRICAL

This is a controller the purpose of which is to monitor the readings taken from the sensors and meters, monitor the performance of the system and control the final control elements in the shape of valves, relays and the mechanical break. The controller is capable of being interfaced with building management systems and/or directly connected to a communications network, such as an internet connection, for providing and receiving information. The controller is capable to limit the amount of electricity export to prevent a surplus of energy that cannot be consumed by the property, to be exported to the distribution network owner's grid.

### E07 ELECTRICAL

This is an electricity meter for recording the electricity imported and exported to the distribution board or consumer unit or similar. The electricity meter is connected to and monitored by the controller.

### H01 HYDRONIC

This is a flanged pipe or similar for connecting the system to an upstream water source from an open loop water system i.e. mains cold water service, boosted cold water services, hot water cold feed or similar.

### H02 HYDRONIC

This is a pressure sensor connected to the controller for monitoring the oncoming water pressure to the pressure reducing valve.

### H03 HYDRONIC

This is a pressure gauge which is used as a visual indicator of the oncoming water pressure to the pressure reducing valve.

### H04 HYDRONIC

This is an adjustable pressure reducing valve for reducing the oncoming water pressure for safe use in both the system and the property downstream of the system. The pressure reducing valve also enables a commissioning engineer to balance and optimise the system in relation to the oncoming water pressure and what the system requires in terms of water pressure.

### H05 HYDRONIC

This is a pressure sensor connected to the controller for monitoring the downstream water pressure from the pressure reducing valve.

### HO6 HYDRONIC

This is a pressure gauge which is used as a visual indicator of the downstream water pressure from the pressure reducing valve.

### H07 HYDRONIC

This is a check valve. Its purpose is to prevent water from being siphoned from the property's water system in the event of a negative pressure being imposed in the open loop water system elsewhere upstream of the property.

### H08 HYDRONIC

This is a water meter connected back to the controller for monitoring water consumption to the property.

### H09 HYDRONIC

This is a motorised two-port control valve that is configured with an actuator for power open and power closed or an actuator for power open and spring return closed, which is held fully open during normal operation. In a fail safe event, the controller signals for this valve to fully close to isolate the system from the open loop system. This action isolates the system while not affecting the operation of the open loop system, i.e. water can still be drawn off the open loop system by the property. This valve may be power open and spring closed so in the event of a loss of power the valve will close and in doing so isolate the system, again, without affecting the open loop system.

### H10 HYDRONIC

This is a drain cock valve and is used during a maintenance event to drain down and safely relieve the water pressure in the accumulator tank should said accumulator tank be isolated from the open loop system.

### H11 HYDRONIC

This is an accumulator tank or expansion vessel or water hammer arrestor or similar. The purpose of this device is to absorb water pressure from the open loop system. This device includes within its shell a water side and a gas side which are separated by means of a bladder, diaphragm or similar. When the open loop system is closed, i.e. zero water is being drawn from the property, water accumulates within the device, and due to the available water pressure, pushes the bladder or diaphragm into the gas pocket. The gas both being a compressible fluid and being displaced by the water has a smaller volume of space and so its pressure rises. When the open loop system is open, i.e. water is being drawn off from the property, a negative pressure is imposed on the whole open loop system and it is this negative pressure which siphons the water from the device, which is also complemented by the gas naturally trying to expand back to its original uncompressed state. As a result the gas pressure falls. It is this gas pressure differential which is being used to produce mechanical work. In this case the gas is inert such air or nitrogen or similar, so in the event of the bladder or diaphragm or similar rupturing, the water is not contaminated. The system is suitable for use with a potable open loop system. These devices have a screwed connection for connection to the open loop system and a Schrader valve. The Schrader valve is used to pre-charge the device with an inert gas however the system uses this connection to power a pneumatic system.

### H12 HYDRONIC

This is a motorised two-port control valve and may be configured with an actuator for power open and power closed, or an actuator for power closed and spring return open, and the actuator may be either electric or pneumatic with the latter providing more rapid open/close times. This valve may be used in a property which has a cold water storage tank for artificially and actively creating pressure fluctuations in the open loop system at intervals to suit the energy harvest of the system. This device may not be employed in an open loop system if it is envisaged the open loop system has many open and close events throughout the day.

### H13 HYDRONIC

This is a flanged pipe or similar for connecting the system to the downstream side of the open loop system, i.e. mains cold water service, boosted cold water services, hot water cold feed or similar feeding a property's appliances, such as taps, showers, dishwashers and the like.

### H14 HYDRONIC

This is an accumulator tank or expansion vessel or water hammer arrestor or similar. The pre-charged gas in this device is being used as a gas-spring for returning the piston of the pneumatic cylinder. It is similar to the device H11 but being used in a different role. Water is used but in a micro closed loop system to ensure the gas side of the device operates as intended.

### H15 HYDRONIC

This is an isolating valve for isolating the accumulator tank from the closed loop system.

### H16 HYDRONIC

This is a pressure gauge used as a visual indicator of the water pressure contained within the closed loop system.

### H17 HYDRONIC

This is a pressure sensor connected to the controller for monitoring the water pressure contained within the closed loop system.

### H18 HYDRONIC

This is a moisture sensor mounted to a drip tray connected to the controller, and should moisture be detected the controller will de-energise the safety relay device E02 and the two-port control valve H10.

### H19 HYDRONIC

This is an anti-legionella valve that is positioned in place of a t-piece for diverting a portion of the flow water into the accumulator tank for encouraging water turnover within the accumulator tank.

### H20 HYDRONIC

This is a through flow expansion vessel that is positioned in place of a traditional accumulator tank or expansion vessel. The through flow expansion vessel ensures water turnover for minimising risks pertaining to legionella proliferation. The motorised 2 port control valve (H09) and drain cock (H10) may not be installed when this type of vessel is used.

### M01 MECHANICAL

This is a technical spacer which is precision engineered to match the pneumatic cylinder piston in-stroke and out-stroke with the connecting rod, which is connected to the crankshaft, along with the mounting points to the mechanical device M02. The technical spacer is mounted to the mechanical device M02 and the pneumatic cylinder is mounted to the technical spacer.

### M02 MECHANICAL

This includes a connecting rod, crank shaft, continuously variable transmission, pulley, driven shaft complete with clutch, head gears and large pulley wheel and pulley break. The connecting rod is connected to the pneumatic cylinder piston adaptor via a pin which goes through the centre of the connecting rod bearing bush which is locked in place by a split pin. The adaptor is then screwed onto the pneumatic cylinder's piston, so that every in-stroke and out-stroke of the piston correlates with crankshaft rotation. This rotational force is transferred through the continuously variable transmission for maximising torque upon start up and then speed once in motion. This force is then ultimately transferred to a large pulley wheel.

### M03A MECHANICAL

This is a large pulley wheel/flywheel which the mechanical device M02 rotates. This large pulley wheel is connected to a tensioner pulley wheel and the generator pulley wheel by a pulley belt.

### M03B MECHANICAL

This is the tensioner pulley wheel which provides tension to the pulley belt.

### M03C MECHANICAL

This is the generator pulley wheel mounted directly to the generator's shaft.

### M04 MECHANICAL

This is a drip tray. The hydronic module sits in a drip tray to enable leaks to be detected via the moisture sensor H18. The position of this drip tray M04 is illustrated schematically in FIG. 16.

### M05 MECHANICAL

The pneumatic hose and moving parts may be shrouded in a protective case.

### M07 MECHANICAL

This includes a crank pin, crank shaft, direct drive axle adaptor. The connecting rod is connected to the pneumatic cylinder piston adaptor via a pin which goes through the centre of the crank pin bearing bush which is locked in place by a split pin. The adaptor is then screwed onto the pneumatic cylinder's piston so that every in-stroke and out-stroke of the piston correlates with crankshaft rotation. This rotational force is transferred through the direct drive axle.

### M08 MECHANICAL

This is an axle with knuckle for facilitating direct drive of the generator without the need of pulley belt.

### M09 MECHANICAL

These are head gears mounted directly to the generator. These gears allow the maximum torque to be applied upon commencement of rotation and maximise rotational speed once the system is up to speed.

### M10 MECHANICAL

This is a coupler for directly coupling the pneumatic vane motor (P32) drive shaft with the driven shaft of an electrical generator (E01).

### P01 PNEUMATIC

This is a female Schrader valve for effecting a permanent and safe connection on to the accumulator tank's Schrader valve.

### P02 PNEUMATIC

This is a pneumatic isolation valve for safely isolating the accumulator tank from the rest of the pneumatic module. In a maintenance event, this valve will be closed prior to the female Shrader valve being unscrewed so as to preserve the air within the pneumatic module, i.e. only a small amount of air is lost in the pneumatic hose in between the female Schrader valve and isolation valve.

### P03 PNEUMATIC

These elements are either three-way pneumatic manifolds or four-way pneumatic manifolds for connecting multiple pneumatic hoses to. These may be amalgamated together into a single larger pneumatic manifold.

### P04 PNEUMATIC

This is a six-way pneumatic manifold and is located close to the pneumatic cylinder to provide a bypass route when the gas is returning back to the accumulator tank during a water draw off event.

### P05 PNEUMATIC

This is an adjustable, non-relieving, pneumatic pressure reducing valve used to safely step down the gas pressure for safe use with the pneumatic cylinder. This device is non-relieving so that the gas within the pneumatic module remains sealed. This device is adjustable to enable the system to be commissioned and optimised in relation with the water pressure exerted upon the system. This device includes a pressure gauge to provide a visual indicator of the downstream pressure onto the pneumatic cylinder.

### P06 PNEUMATIC

This is a pneumatic non-return valve for containing the high pressure side of the pneumatic module upstream of the pressure reducing valve, while providing a bypass route for the returning gas when the gas pressure within the accumulator tank falls.

### P07 PNEUMATIC

This is a pneumatic safety relief valve for providing a safe and mechanical means of venting the pneumatic module in a hazardous high pressure event. This device is located on the low pressure side of the pneumatic module.

### P08 PNEUMATIC

This is a pneumatic safety relief valve for providing a safe and mechanical means of venting the pneumatic module in a hazardous high pressure event. This device is located on the high pressure side of the pneumatic module.

### P09 PNEUMATIC

This is a pressure sensor connected to the controller for monitoring the gas pressure on the high pressure side of the pneumatic module.

### P10 PNEUMATIC This is a pressure gauge which is used as a visual indicator of the gas pressure on the high pressure side of the pneumatic module.

### P11 PNEUMATIC

This is a moisture sensor connected to the controller for monitoring moisture/water in the pneumatic module. In the event water is detected, which may signify a potential rupture of the accumulator tank's bladder, diaphragm or similar: the motorised two-port control valve H10 is either powered to close or if a spring closed type valve has been installed, the valve will be de-energised so that the valve closes and isolates the system from the open loop system without impacting on the open loop system's operation. Furthermore, the controller de-energises the safety relay device E02.

### P12 PNEUMATIC

This is a male Schrader fill point which enables the system to be topped up with gas without having to disconnect the accumulator tank during a maintenance event.

### P13 PNEUMATIC

This is a pneumatic cylinder with a piston which is extended and retracted due to gas pressure fluctuations within the pneumatic module. Alternative types of pneumatic device may be used for converting the energy within the gas to mechanical work.

### P14 PNEUMATIC

This is a pneumatic cylinder piston adaptor which screws onto the end of the pneumatic cylinder's piston. The pin of the Y-clevis adaptor is pushed through a crank pin bearing bush which forms the link between the pneumatic cylinder creating linear action and a crank shaft which produces rotational action.

### P15 PNEUMATIC

These are either three-way pneumatic manifolds or four-way pneumatic manifolds for connecting multiple pneumatic hoses to. These manifolds may be amalgamated together into a single larger pneumatic manifold.

### P16 PNEUMATIC

This is a pneumatic safety relief valve for providing a safe and mechanical means of venting the pneumatic module in a hazardous high pressure event. This device is located on the gas-spring pneumatic system.

### P17 PNEUMATIC

This is a male Schrader fill point which enables the system to be topped up with gas without having to disconnect the accumulator tank during a maintenance event.

### P18 PNEUMATIC

This is a pressure sensor connected to the controller for monitoring the gas pressure in the gas spring pneumatic system.

### P19 PNEUMATIC

This is a pressure gauge which is used as a visual indicator of the gas pressure in the gas spring pneumatic system.

### P20 PNEUMATIC

This is a female Schrader valve for achieving a permanent and safe connection on to the accumulator tank's Schrader valve.

### P21 PNEUMATIC

This is a compressor and is powered and controlled from the controller. This provides the system with the functionality of remotely optimising the gas pressure contained within the pneumatic system. The compressor is de-energised and locked out in a high pressure/limit event. The compressor when energised, pushes air from atmosphere into the sealed loop pneumatic system.

### P22 PNEUMATIC

This in an automatic exhaust valve and is powered and controlled from the controller. This provides the system with the functionality of remotely optimising the gas pressure contained within the pneumatic system. The automatic exhaust valve when opened exhausts the closed loop pneumatic gas to atmosphere.

### P23 PNEUMATIC

This is a compressor and is powered and controlled from the controller. This provides the system with the functionality of remotely optimising the gas pressure contained within the pneumatic system. The compressor is de-energised and locked out in a high pressure/limit event. The compressor when energised, pushes air from atmosphere into the sealed loop pneumatic system.

### P24 PNEUMATIC

This is an automatic exhaust valve and is powered and controlled from the controller. This provides the system with the functionality of remotely optimising the gas pressure contained within the pneumatic system. The automatic exhaust valve when opened exhausts the closed loop pneumatic gas to atmosphere.

### P25 PNEUMATIC

This is a pressure sensor connected to the controller for monitoring the gas pressure on the low pressure side of the pneumatic module.

### P26 PNEUMATIC

This is a pressure gauge which is used as a visual indicator of the gas pressure on the low pressure side of the pneumatic module.

### P27 PNEUMATIC

This is a high pressure receiver tank for containing high pressure gas. The receiver tank may be a cylinder or an expansion vessel/accumulator tank with internal diaphragm or bladder or similar for receiving the gas and ejecting the gas when the accumulator tank H11 is pulling the gas back to source.

### P28 PNEUMATIC

This is a low pressure receiver tank for containing low pressure gas. The receiver tank may be a cylinder or an expansion vessel/accumulator tank with internal diaphragm or bladder or similar for receiving the gas and ejecting the gas when the accumulator tank H11 is pulling the gas back to source.

### P29 PNEUMATIC

This is a non-return valve for ensuring all gas pumped into the high pressure receiver tank (P28) does not bypass the pneumatic vane motor (P32).

### P30 PNEUMATIC

This is a pneumatic (electric) motorised 2 port control valve. This valve opens when the accumulator tank (H11) imposes a negative pressure on the low pressure receiver tank (P28) and when motorised control valve (P31) is closed. When the low pressure set point has been met, pneumatic (electric) motorised 2 port control valve (P30) closes to maintain the lower pressure in the receiver tank.

### P31 PNEUMATIC

This is a pneumatic (electric) motorised 2 port control valve. During the charge up of the high pressure receiver tank: pneumatic (electric) motorised 2 port control valve (P31) is closed. When the correct pressure differential between the high and low pressure receiver tanks (P27 and P28) has been achieved with the motorised 2 port control valve (P38) closed, this valve opens to permit a sustained amount of gas to enter and pass through the pneumatic vane motor (P32).

### P32 PNEUMATIC

This is a pneumatic vane motor or similar. The passage of air across the device rotates a turbine which directly drives a shaft to rotate. This shaft is directly coupled to the driven shaft of a generator for producing electricity.

### P33 PNEUMATIC

This is a non-return valve for ensuring no gas is pumped into the low pressure receiver tank (P28).

### P34 PNEUMATIC

This is a pressure sensor connected to the controller for monitoring the gas pressure on the high pressure side of the pneumatic module.

### P35 PNEUMATIC

This is a pressure gauge which is used as a visual indicator of the gas pressure on the high pressure side of the pneumatic module.

### P36 PNEUMATIC

This is a pressure sensor connected to the controller for monitoring the gas pressure on the low pressure side of the pneumatic module.

### P37 PNEUMATIC

This is a pressure gauge which is used as a visual indicator of the gas pressure on the low pressure side of the pneumatic module.

### P38 PNEUMATIC

This is a pneumatic (electric) motorised 2 port control valve. This control valve ensures the accumulator vessel (H11) does not decant the entirety of its gas into the receiver tanks (P27 and P28). When the high pressure set point has been met, the pneumatic (electric) motorised 2 port control valve (P38) closes to maintain the high pressure in the receiver tank.

### P39 PNEUMATIC

These are pneumatic non-return valves used for directing the gas through the two pneumatic vane motors (P32) in the correct direction to enable the correct rotation for electricity to be produced from the generators.

### P40 PNEUMATIC

This is a receiver for receiving pressurised gas from the accumulator vessel (H11). The receiver tank may be a cylinder or an expansion vessel/accumulator tank with internal diaphragm or bladder or similar for receiving the gas and ejecting the gas when the accumulator tank H11 is pulling the gas back to source.

### P41 PNEUMATIC

These are non-return valves. These valves are arranged in a way to direct the gas across the pneumatic vane motor (P32) in the correct direction so that the generator produces electricity irrespective if the gas is flowing to or from the accumulator vessel (H11). These valves permit gas flow to the receiver (P40).

### P42 PNEUMATIC

These are non-return valves. These valves are arranged in a way to direct the gas across the pneumatic vane motor (P32) in the correct direction so that the generator produces electricity irrespective if the gas is flowing to or from the accumulator vessel (H11). These valves permit gas flow to the accumulator vessel (H11).

### P43 PNEUMATIC

This is an adjustable, non-relieving, pneumatic pressure reducing valve used for commissioning and to reduce the rate at which gas moves across the pneumatic vane motor (P32) to prolong electrical generation.

The following components denoted with an ‘X’ may be provided as part of an external arrangement with which the system of the invention is connected to and which the system of the invention operates in conjunction with. The components X01 to X04 are illustrated in FIG. 15.

### X01

This is a stop cock valve for isolating the water supply to a property.

### X02

This is a drain cock valve for draining water from the system when the stop cock has isolated the water supply to the property.

### X03

This is an isolation valve for isolating the water supply downstream of the system. If both the stop cock and isolation valve are closed then only a partial drain down of the system is needed through the drain cock for draining the system down of water to enable the system to be maintained.

### X04

This is a distribution board or consumer unit or similar for exporting generated electricity from the system for use within a property.

The system 1 of the invention has several advantages compared to a simple hydro electric generator. The system 1 is an indirect generator with no contact between the water and the mechanical device. The system 1 produces electricity when the pressure is released, that is when a tap opens. Electricity is not produced by water draw off per say. The system 1 may be configured to produce electricity when zero water is being drawn off. The system 1 generates electricity based on the number of times an appliance is opened and closed which results in a reduced risk of building operators or homeowners drawing off more water than needed to satisfy the electrical demands of the building. The system 1 of the invention takes into account how the water is drawn off rather than how much water is drawn off. The system 1 generates electricity with a low-cost, simple arrangement without requiring bespoke, expensive component parts. The system 1 may be used with a 22 mm connection to the water main irrespective of the size of the potable open loop pipe size or the size of the generator. A 4 KW generator may be supported with a 22 mm pipe size. In the event of any system failure, the open loop system is unhindered. The system 1 includes the sealed pneumatic system in which no gas is relieved or exhausted to atmosphere during normal operation.

In FIG. 12 there is illustrated another system 20 according to the invention for harnessing a pressure fluctuation of a liquid, which is similar to the system 1 of FIGS. 1 to 11, and similar elements in FIG. 12 are assigned the same reference numerals.

In this case an alternative cylinder may be used for aiding the return of the piston 9 in time for the next stroke, such as a spring return cylinder instead of a gas spring type system.

The system 20 includes a direct current motor with alternative electrical and gear configurations.

The system 20 includes the following component in the electrical module:

### E08 ELECTRICAL

This is the generator. Unlike in the generator E01 in the system 1 of FIGS. 1 to 11, this generator E08 produces direct current and therefore does not require a rectifier E03.

The system 20 includes the following component in the mechanical module:

### M06 MECHANICAL

As an alternative to the arrangement in the system 1 of FIGS. 1 to 11, this is a technical spacer for marrying up the pneumatic cylinder rod in-strokes and out-strokes with the connecting rod, which is connected to the crankshaft, along with the mounting points to the mechanical device M07. The technical spacer is mounted to the mechanical device M02 and the pneumatic cylinder is mounted to the technical spacer.

In this case the system 20 does not include a two-port solenoid valve. The system 20 is suitable for operation with multiple draw off events.

FIG. 13 illustrates another system 30 according to the invention for harnessing a pressure fluctuation of a liquid, which is similar to the system 1 of FIGS. 1 to 11, and similar elements in FIG. 13 are assigned the same reference numerals.

In this case the system 30 includes mini-compressors and automated exhaust valves which allow for remote charge and discharge of the pneumatic system.

Referring to FIG. 14 there is illustrated another system 40 according to the invention for harnessing a pressure fluctuation of a liquid, which is similar to the system 1 of FIGS. 1 to 11, and similar elements in FIG. 14 are assigned the same reference numerals.

In this case a single pneumatic module provides energy to multiple mechanical and electrical modules via a pneumatic manifold. The number of circuits may vary depending on the available pneumatic pressure in the vessel.

FIG. 15 illustrates schematically the boundary of the system of the invention in relation to how it is connected to the overall water and electrical systems.

FIG. 16 illustrates schematically the internal modules of the system of the invention. 1H* is the hydronic module, 1P* is the pneumatic module, 1M* is the mechanical module, and 1E* is the electrical module. The diagram also indicates a drip trip and moisture sensor H18.

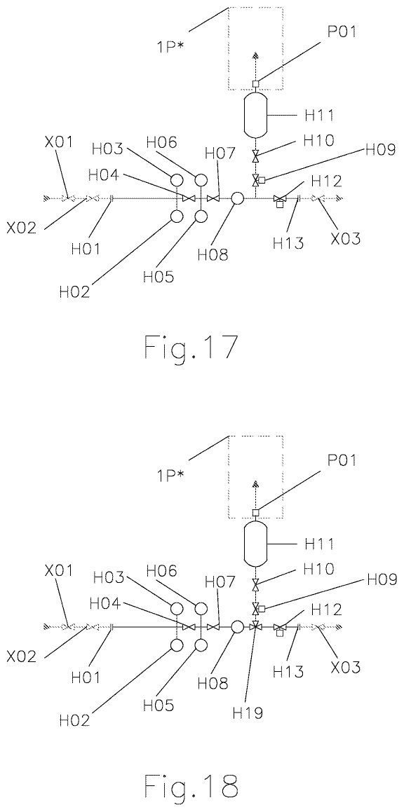

FIG. 17 is an exploded diagram of the hydronic module indicating the standard hydronic arrangement.

FIG. 18 is an exploded diagram of the hydronic module indicating the standard hydronic arrangement with the anti-legionella valve (H19).

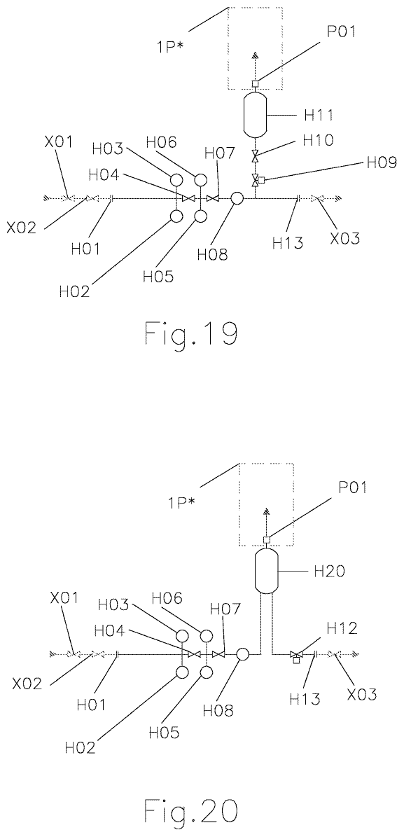

FIG. 19 is an exploded diagram of the hydronic module indicating the standard hydronic arrangement without the 2 port motorised control valve for creating pressure fluctuations.

FIG. 20 is an exploded diagram of the hydronic module indicating the standard hydronic arrangement using a through flow expansion vessel instead of a regular accumulator tank.

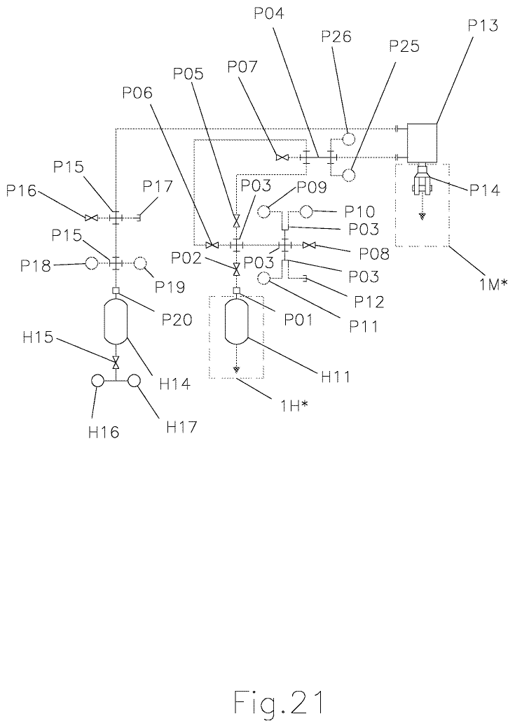

FIG. 21 is an exploded diagram of a pneumatic module using two sealed pneumatic systems for the purpose of extending and retracting the pneumatic piston.

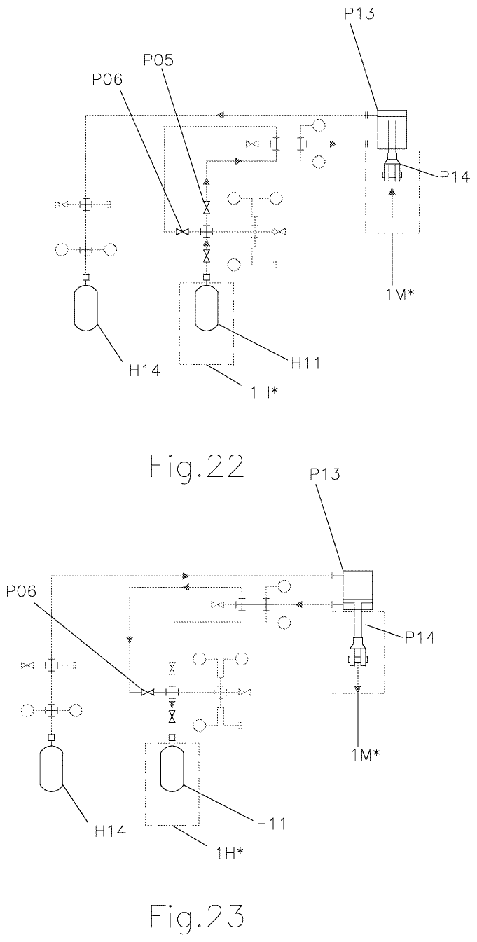

FIG. 22 is a stripped down version of FIG. 21, indicating high pressure gas being pushed into the cylinder which acts to retract the piston into the cylinder. The resulting retraction pushes back on the gas spring provided by the micro-sealed pneumatic system.

FIG. 23 is a stripped down version of FIG. 21, indicating low pressure gas being returned to the accumulator vessel. The negative pressure imposed on the cylinder is complemented by the high pressure gas spring provided by the micro-sealed pneumatic system which extends the piston out of the cylinder.

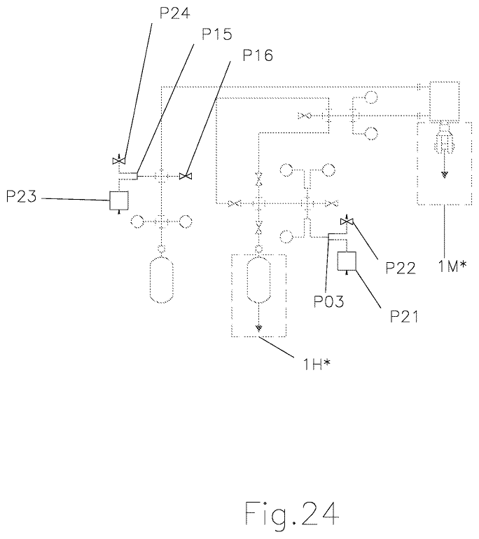

FIG. 24 is an exploded diagram indicating micro-compressors and controllable exhaust valves which enable the pneumatic sealed system to be adjusted remotely for optimisation.

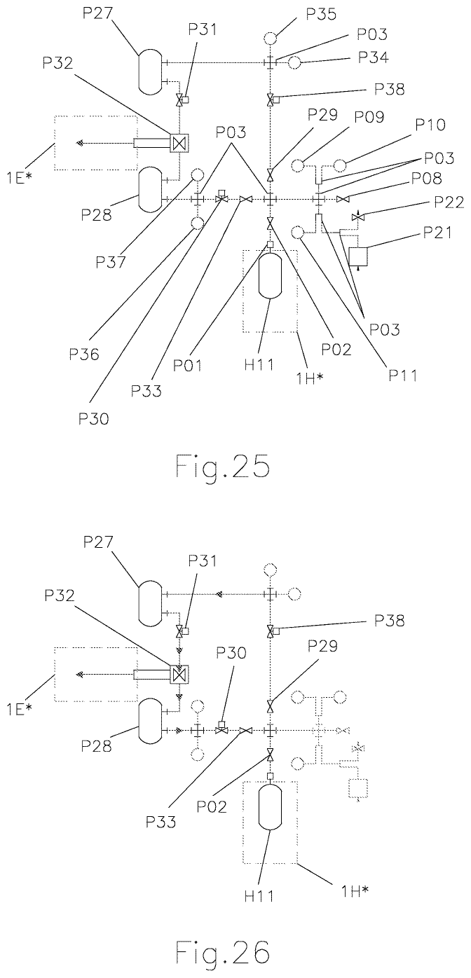

FIG. 25 is an exploded diagram of a pneumatic module using two receiver tanks, a pneumatic vane motor and number of sensors and valves. The pneumatic vane motor's turbine is rotated by the gas which turns its integral drive shaft. This drive shaft is directly coupled to the driven shaft of an electrical generator for producing electricity. The pneumatic arrangement allows gas to be built up in pressure and released in stages for prolonged electrical generation. This arrangement permits electricity to be produced when water is not being drawn off from an open loop network.

FIG. 26 is a stripped down version of FIG. 25, indicating the gas being decanted from the pneumatic module back into the accumulator tank during a water draw off event. This is made possible by the 2 port control valve (P38) being closed. Once the low pressure set point has been met, the 2 port control valves (P30 and P31) close.

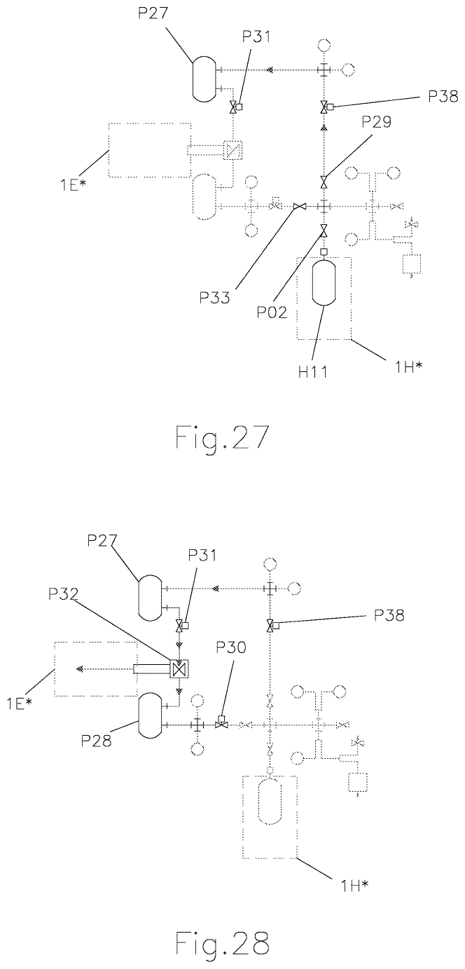

FIG. 27 is a stripped down version of FIG. 25, indicating the gas being pushed into the high pressure receiver tank (P27), when the accumulator tank has been fully charged with water, equating to high pressure gas. This function is permitted by opening the 2 port control valve (P38). The 2 port control valve (P38) is closed upon the high pressure set point being met.

FIG. 28 is a stripped down version of FIG. 25, indicating gas flow from the high pressure receiver tank to the low pressure receiver tank upon opening the 2 port control valve (P31). This enables a sustained amount of gas to flow through the pneumatic vane motor. Should the transfer of air be too fast and of short duration, then a pressure reducing valve may be installed to prolong electrical generation immediately upstream of the pneumatic vane motor. Once the pressure balances out between both receiver tanks, the 2 port control valve (P30) opens to enable the gas to be decanted back to the accumulator vessel to enable the process to begin again.

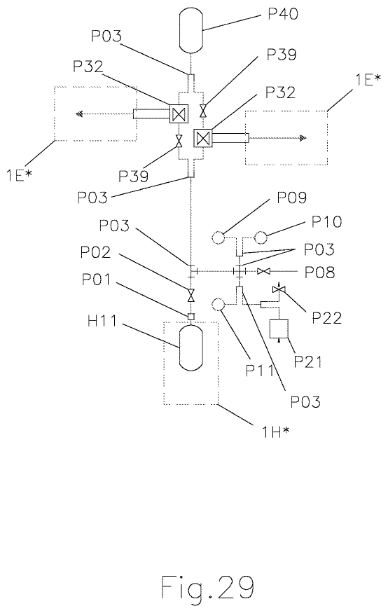

FIG. 29 is an exploded diagram of a pneumatic module using two pneumatic vane motors used in tandem with two non-return valves. The non-return valves ensure the correct direction of gas is provided across the pneumatic vane motors to enable electricity generation.

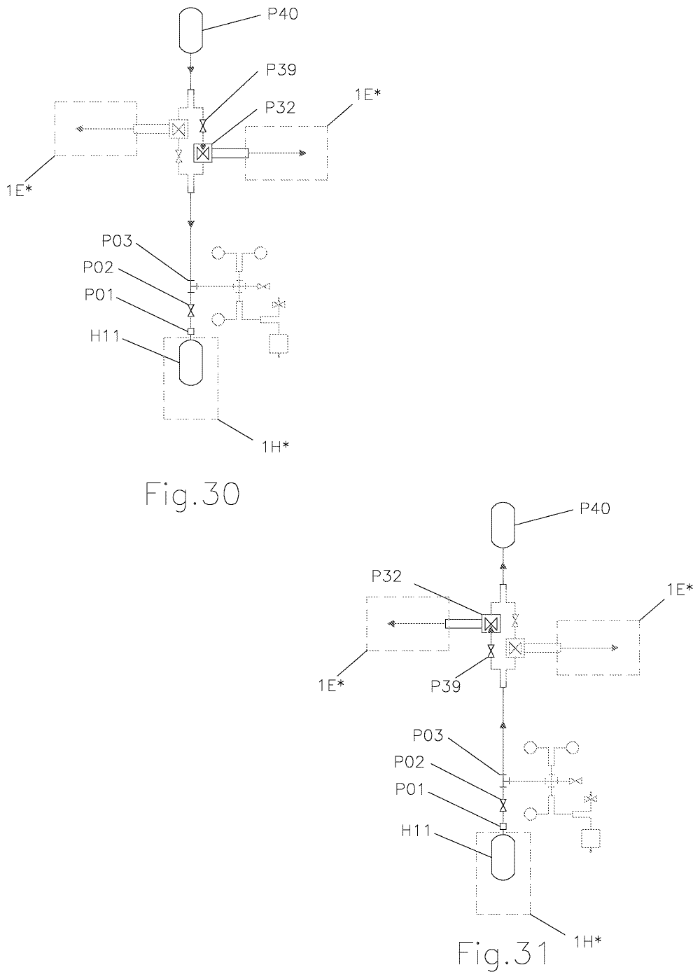

FIG. 30 is a stripped down version of FIG. 29, indicating gas being decanted from the pneumatic module back to the accumulator vessel, during water draw off. The non-return valves direct the gas through the pneumatic vane motor/generator arrangement which is compatible with this direction of travel.

FIG. 31 is a stripped down version of FIG. 29, indicating gas being pushed into the receiver from the accumulator vessel, when the accumulator vessel is being charged with water. The non-return valves direct the gas through the pneumatic vane motor/generator arrangement which is compatible with this direction of travel.

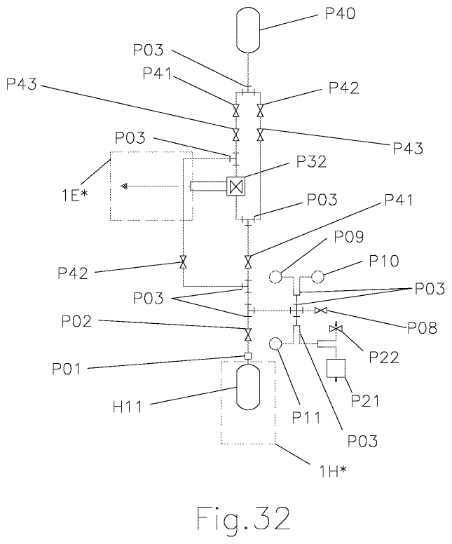

FIG. 32 is an exploded diagram of a pneumatic module which is a refinement of the pneumatic module indicated under FIG. 29. Four non-return valves are arranged in a manner to permit a single direction of gas across a single pneumatic vane motor/generator arrangement for producing electricity. The pressure reducing valves installed in each leg act to hold back the gas for prolonged gas flow and subsequent generation of electricity.

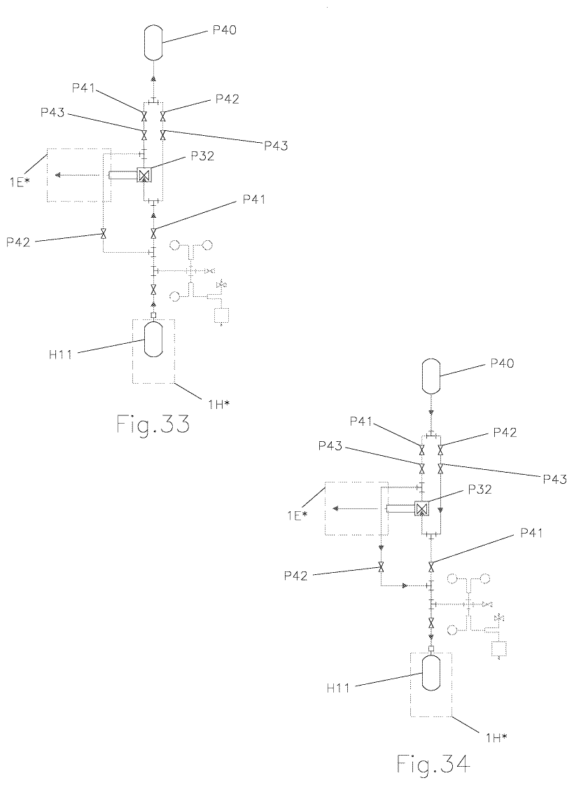

FIG. 33 is a stripped down version of FIG. 32, indicating gas being pushed into the receiver from the accumulator vessel, when the accumulator vessel is being charged with water.

FIG. 34 is a stripped down version of FIG. 32, indicating gas being decanted from the pneumatic module back to the accumulator vessel, during water draw off.

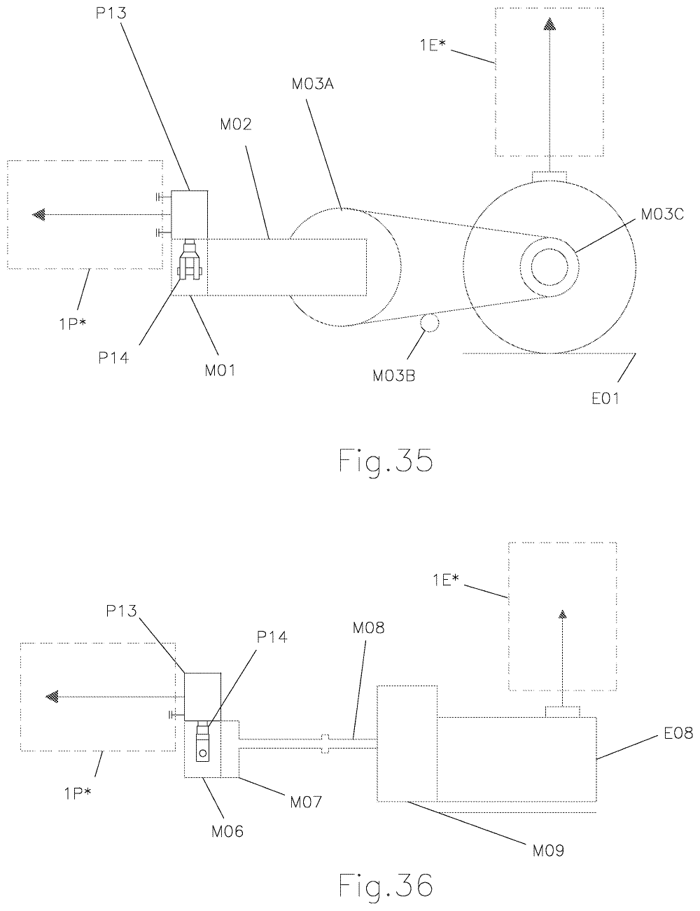

FIG. 35 is an exploded diagram of a mechanical module using a pneumatic piston to drive a continuously variable transmission for driving a pulley system.

FIG. 36 is an exploded diagram of a mechanical module using a pneumatic piston to drive a direct-drive without the use of pullies system.

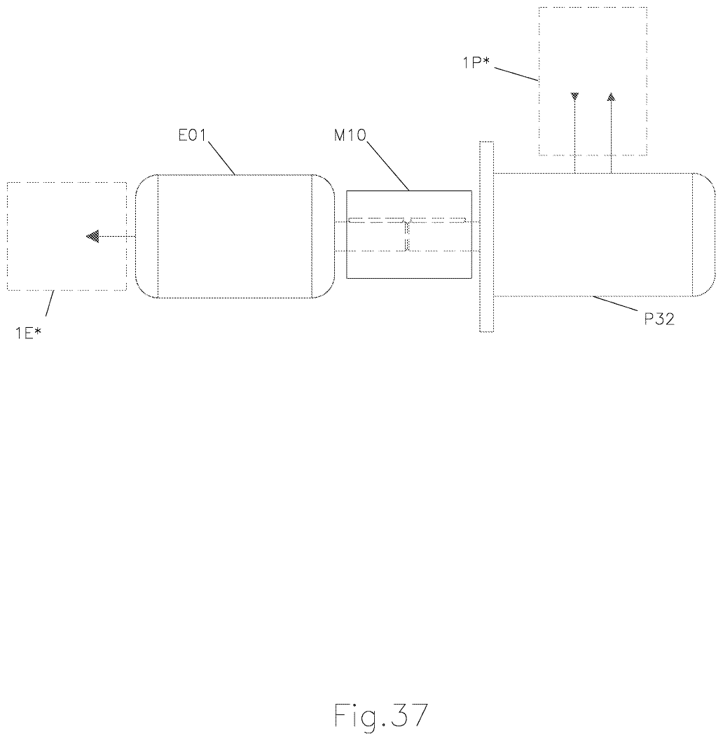

FIG. 37 is an exploded diagram of a mechanical module using a pneumatic vane motor in conjunction with an electrical generator. The drive shaft is directly coupled with the driven shaft of the generator which rotates to produce electricity.

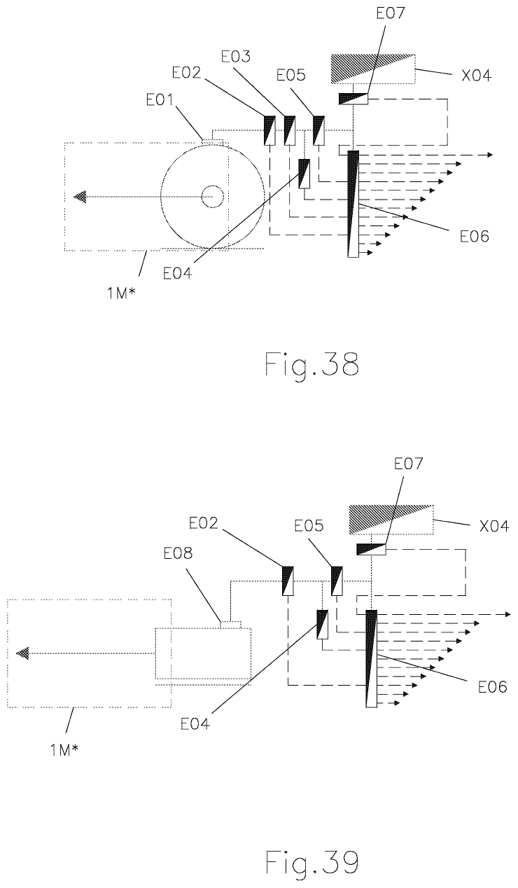

FIG. 38 is an exploded diagram of an electrical module using an alternating current generator.

FIG. 39 is an exploded diagram of an electrical module using a direct current generator.

Throughout the description and claims of this specification, the words “comprise” and “contain” and variations of them mean “including but not limited to” and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of the features and/or steps are mutually exclusive. The invention is not restricted to any details of any foregoing embodiments. The invention extends to any novel one, or novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1-25. (canceled)

26. A system for harnessing a pressure fluctuation of a liquid, the system comprising:
an accumulator element having a reception space for receiving a liquid and a container space for containing a gas,
the accumulator element having a transfer element to transfer an input pressure fluctuation in the reception space to an output pressure fluctuation in the container space, and
a pneumatic actuator,
the container space being coupled to the pneumatic actuator to cause movement of at least part of the pneumatic actuator responsive to the output pressure fluctuation.

27. A system as claimed in claim 26 wherein the transfer element comprises a flexible diaphragm to separate the reception space from the container space.

28. A system as claimed in claim 26 wherein the system comprises one or more valve elements between the container space and the pneumatic actuator to couple the container space to the pneumatic actuator.

29. A system as claimed in claim 26 wherein the pneumatic actuator comprises an enclosure element and a piston rod element, the piston rod element being movable relative to the enclosure element in a translational manner.

30. A system as claimed in claim 29 wherein the system comprises means to convert translational movement of the piston rod element into rotational movement of a shaft element.

31. A system as claimed in claim 30 wherein the means to convert comprises a crank shaft element.

32. A system as claimed in claim 30 wherein the system comprises means to generate electrical power from the rotational movement of the shaft element.

33. A system as claimed in claim 26 wherein the reception space of the accumulator element is configured to receive water.

34. A system as claimed in claim 33 wherein the system comprises means to couple the reception space of the accumulator element to an open loop water system.

35. A system as claimed in claim 34 wherein the system comprises means to couple the reception space of the accumulator element to a potable open loop water system.

36. A system as claimed in claim 26 wherein the container space of the accumulator element is configured to contain air or nitrogen.

37. A system as claimed in claim 26 wherein the pneumatic actuator is a sealed non-relieving non-exhausting pneumatic system.

38. A system as claimed in claim 26 wherein the system comprises a motorised control valve to direct the liquid to the accumulator element in the event of a liquid draw off event.

39. A system as claimed in claim 26 wherein the system comprises a pneumatic vane motor.

40. A method for harnessing a pressure fluctuation of a liquid, the method comprising the steps of:
containing a gas in a container space of an accumulator element,
receiving a liquid in a reception space of the accumulator element,
upon a pressure fluctuation in the liquid in the reception space, transferring the pressure fluctuation to the gas in the container space, and
causing movement of at least part of a pneumatic actuator responsive to the pressure fluctuation in the gas.

41. A method as claimed in claim 40 wherein the pressure fluctuation in the gas causes movement of the part of the pneumatic actuator in a translational manner.

42. A method as claimed in claim 40 wherein the method comprises the step of converting translational movement of the part of the pneumatic actuator into rotational movement of a shaft element.

43. A method as claimed in claim 42 wherein the method comprises the step of generating electrical power from the rotational movement of the shaft element.

44. A method as claimed in claim 40 wherein the method comprises the step of coupling the reception space of the accumulator clement to an open loop water system.

45. A method as claimed in claim 44 wherein the method comprises the step of coupling the reception space of the accumulator clement to a potable open loop water system.
